(19) United States
(12) Patent Application Publication
(10) Pub. No.: US 2011/0229861 A1
(43) Pub. Date: Sep. 22, 2011

(54) EDUCATIONAL GAME APPARATUS

(76) Inventor: Emil Woods, Rosenberg, TX (US)

(21) Appl. No.: 12/728,159

(22) Filed: Mar. 19, 2010

(51) Int. Cl. G09B 19/22; G09B 25/06

(52) U.S. Cl. 434/128; 434/130

(57) ABSTRACT

A game and method of playing game teaches players thereof about geography. The game includes a playing surface having a geographical area divided into subregions illustrated thereon, the geographical area and subregions having geographically significant shapes. A plurality of cards are provided with each card having indicia thereon which represents one of said subregions. A plurality of markers (e.g., pushing pins) are provided as playing pieces, one color for each player and one marker for each card. These markers are used to attach to the playing surface within a plurality of the subregions.

### BACKGROUND OF THE INVENTION

The present embodiment generally relates to a game and method of playing a game, and more specifically, to a game wherein players are entertained while being educated about geography.

It is well known that people learn more efficiently if a learning experience is enjoyable and enables the person being taught to actively participate in the learning process. It is for this reason that educators have often created games that embody the subject that is to be taught.

A number of games for teaching the players about the world's geography or the geography of a specific region of the world exist. They may be complicated and not be suitable for young kids and senior citizens.

Therefore, it can be seen that there is a need for a simple game and method of playing game to meet a demand to such groups of people.

### SUMMARY

In one aspect, a game comprises a playing surface having a geographical area divided into subregions illustrated thereon, said geographical area and said subregions having geographically significant shapes; a plurality of cards, at least one card having indicia thereon which represents one of said subregions; and a marker attaching to the playing surface within a plurality of the subregions.

In another aspect, a method of playing a geographical game comprises: choosing a game which has a playing surface, said playing surface having a geographical area divided into subregions illustrated thereon, said geographical area and said subregions having geographically significant shapes; selecting a plurality of cards, at least one card having indicia thereon which represents one of said subregions; determining an order of play as between a plurality of players which are to play said game; each player selecting a plurality of the markers as a playing piece; performing, by each player, one player at a time, according to said order of play, the following game play steps: selecting a card and identifying a subregion on said playing surface which corresponds to the indicia on said card; attaching a portion of the player's marker to said playing surface within the subregion which corresponds to the indicia on said selected first card; discarding the card; and repeating the game play steps until each player accumulates a first predetermined level of points, has attached their markers to said playing surface, or finishes all the cards.

In a further aspect, a method of playing a geographical game comprises: choosing a game which has a playing surface, said playing surface having a geographical area divided into subregions illustrated thereon, said geographical area and said subregions having geographically significant shapes; selecting a plurality of cards, at least one card having indicia thereon which represents one of said subregions; determining an order of play as between a plurality of players which are to play said game; each player selecting a plurality of the markers as a playing piece; performing, by each player, one player at a time, according to said order of play, the following game play steps: passing one or more card to another player; selecting a card and identifying a subregion on said playing surface which corresponds to the indicia on said card; attaching a portion of the player's marker to said playing surface within the subregion which corresponds to the indicia on said selected first card; discarding the card; and repeating the game play steps until each player accumulates a first predetermined level of points, has attached their markers to said playing surface, or finishes all the cards.

These and other features, aspects and advantages of the present invention will become better understood with reference to the following drawings, description and claims.

### BRIEF DESCRIPTION OF THE DRAWINGS

FIG. 1 is a plan view of a master sheet for scoring according to an exemplary embodiment of the present invention wherein the geography of the North American is to be learned;

FIG. 2 is a plan view of a playing surface of the game according to the exemplary embodiment of the present invention shown in FIG. 1; and

FIG. 3 is a plan view of a front and back of a card according to one exemplary embodiment of the present invention.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

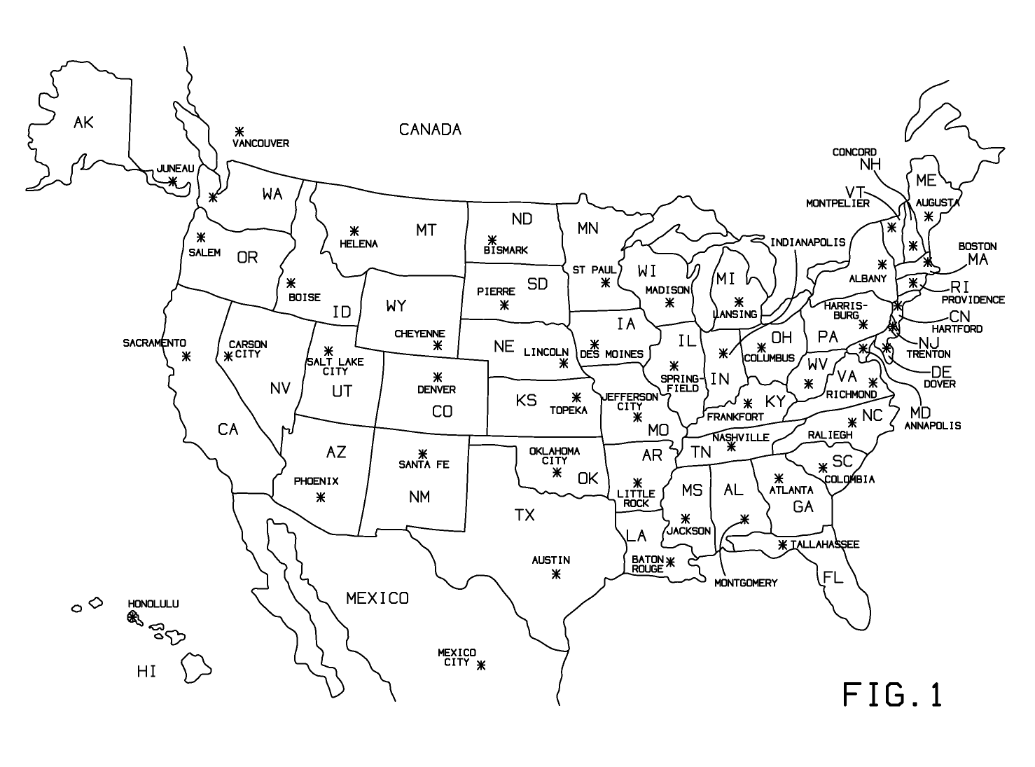

Broadly, exemplary embodiments provide a game and method of playing game. More specifically, an embodiment of the present invention may include one deck of cards 13 and at least four different colors of markers 15 (e.g. push pins) with a map of North America 10, which may be 24 in×24 in, for example. In an exemplary embodiment, the cards 13 may represent the fifty states, Canada, and Mexico, for a total of fifty-two cards 13. The present invention may further comprise individual game boards 11. Furthermore, FIG. 1 depicts a master sheet of the North America map with all of the states and capitals marked. The master sheet may be used for the correct location of the states and capitals on the map. Canada and Mexico may be shown with country names and their capitals.

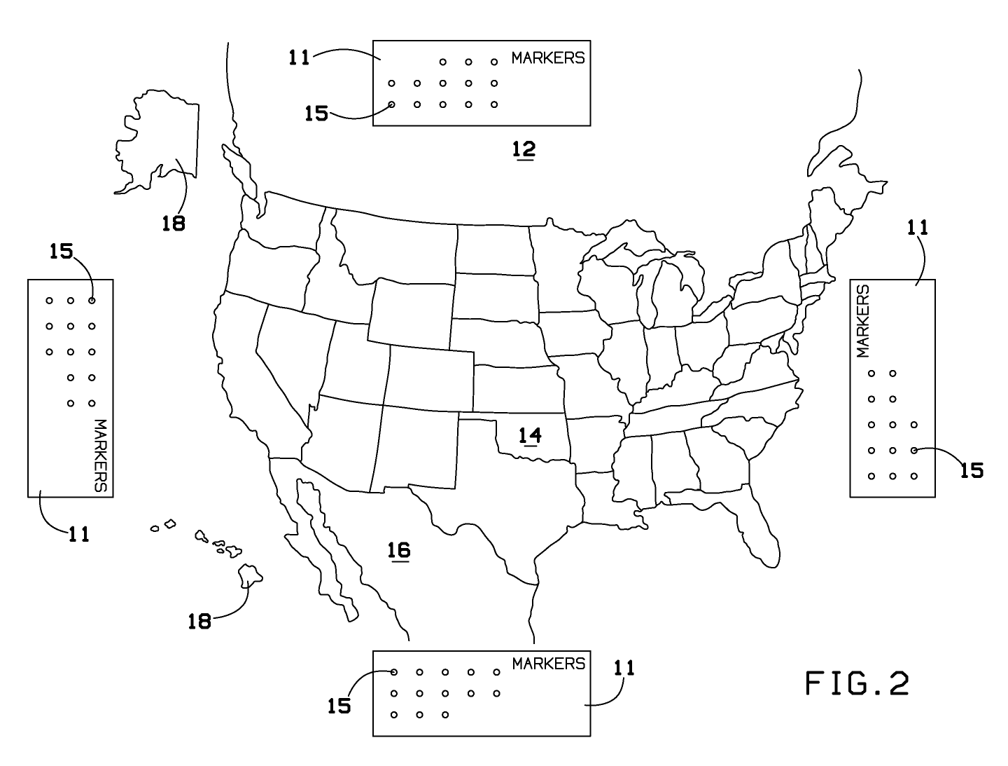

FIG. 2 illustrates a map of North America which includes the United States 14, Mexico 16, and Canada 12. When the geographical area is the United States 14, the subregions are each state. These states have geographically significant shapes. Herein, the term “geographically significant shapes” is intended to mean that a player may easily indentify the difference between one subregion from another subregion.

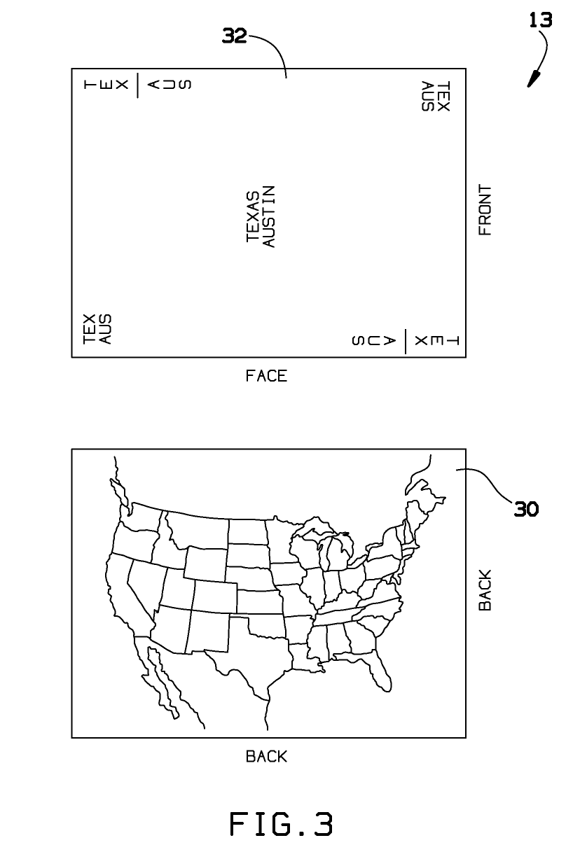

As shown in FIG. 3, in an exemplary embodiment, each card 13 may have a name of the State 18 [see FIG. 2] and its capital on its face 32, and a picture of North America on its back 30. Alternatively, its back 30 may have other designs. Each card 13 may have a regular playing card size, for example, 3.5 in×2.5 in. Furthermore, as an example, four players may deal all 52 cards, with thirteen cards each. In addition, each player may have 13 markers, e.g., push pins, with the same color before starting the game. A dealer may be needed for playing the game. A player to a dealer's left may start to place four markers on the map to match four cards in the player's hand, for example. Next player then may place four markers on the map to match four cards in the player's hand.

Alternatively, each player may pass one, or two, or three cards at one time, for example, of his/her choice to another person. The dealer may decide which game may be played. Each player may take turns before a winning number of points are scored or all markers may be placed. Players may decide the winning number of points before a game starts. A long game may needs 100 points to finish. Alternatively, a short game may need 50 points. One point may be scored for each correct placement. A negative one point may be scored for each incorrect placement. A five point bonus may be given for each of the two bonus cards: Canada and Mexico. Players may make up their own games.

An entire series of games for learning different geographical areas may be provided. An illustrative list of possible geographical area may include the entire world; the United States of America; the African Continent; Asia; the People's Republic of China; the Caribbean islands; Europe; the countries surrounding the Persian Gulf-Arabian Sea; the countries surrounding the Red Sea; and the South American continent.

It should be understood, of course, that the foregoing relate to exemplary embodiments of the invention and that modifications may be made without departing from the spirit and scope of the invention as set forth in the following claims.

We claim:

1. A game comprising:
a playing surface having a geographical area divided into subregions illustrated thereon, said geographical area and said subregions having geographically significant shapes;
a plurality of cards, at least one card having indicia thereon which represents one of said subregions; and
a marker attaching to the playing surface within a plurality of the subregions.

2. The game of claim 1, wherein the geographical area is a map of the United States, each of said subregions being a particular state.

3. The game of claim 1, wherein the marker is one of a push pin, a peg, and a magnet.

4. The game of claim 1, wherein the indicia on each card represents a name of a corresponding subregion and its capital.

5. A method of playing a geographical game, said method comprising:
choosing a game which has a playing surface, said playing surface having a geographical area divided into subregions illustrated thereon, said geographical area and said subregions having geographically significant shapes;
selecting a plurality of cards, at least one card having indicia thereon which represents one of said subregions;
determining an order of play as between a plurality of players which are to play said game;
each player selecting a plurality of the markers as a playing piece;
performing, by each player, one player at a time, according to said order of play, the following game play steps:
selecting a card and identifying a subregion on said playing surface which corresponds to the indicia on said card;
attaching a portion of the player's marker to said playing surface within the subregion which corresponds to the indicia on said selected first card;
discarding the card; and
repeating the game play steps until each player accumulates a first predetermined level of points, has attached their markers to said playing surface, or finishes all the cards.

6. The method according to claim 5, wherein said geographical area is the United States, each subregion being a particular state,

7. The method according to claim 5, the indicia on said cards represents a name of a state, and an additional information is a capital of a state, whereby the players must identify a state by location and the capital of that state to collect an number of points.

8. A method of playing a geographical game, said method comprising:
choosing a game which has a playing surface, said playing surface having a geographical area divided into subregions illustrated thereon, said geographical area and said subregions having geographically significant shapes;
selecting a plurality of cards, at least one card having indicia thereon which represents one of said subregions;
determining an order of play as between a plurality of players which are to play said game;
each player selecting a plurality of the markers as a playing piece;
performing, by each player, one player at a time, according to said order of play, the following game play steps:
passing one or more card to another player;
selecting a card and identifying a subregion on said playing surface which corresponds to the indicia on said card;
attaching a portion of the player's marker to said playing surface within the subregion which corresponds to the indicia on said selected first card;
discarding the card; and
repeating the game play steps until each player accumulates a first predetermined level of points, has attached their markers to said playing surface, or finishes all the cards.

9. The method according to claim 8, wherein said geographical area is the United States, each subregion being a particular state.

10. The method according to claim 8, the indicia on said cards represents a name of a state, and an additional information is a capital of a state, whereby the players must identify a state by location and the capital of that state to collect an number of points.
